(19) United States
(12) Patent Application Publication
(10) Pub. No.: US 2021/0368109 A1
(43) Pub. Date: Nov. 25, 2021

(54) High-speed image readout and processing

(71) Applicant: Waymo LLC, Mountain View, CA (US)

(72) Inventors: Andreas Wendel, Mountain View, CA (US); Jeremy Dittmer, Mountain View, CA (US); Brendan Hermalyn, Mountain View, CA (US)

(21) Appl. No.: 17/394,823

(22) Filed: Aug. 5, 2021

Related U.S. Application Data
(63) Continuation of application No. 16/214,589, filed on Dec. 10, 2018.
(60) Provisional application No. 62/612,294, filed on Dec. 29, 2017.

(51) Int. Cl. H04N 5/247; H04N 5/232; G06T 7/20; H04N 5/917; H04N 7/12; H04N 5/77; H04N 9/804

(52) U.S. Cl. CPC H04N 5/247; H04N 5/23229; G06T 7/20; B60R 2011/0026; H04N 7/12; H04N 5/77; H04N 9/8042; H04N 5/917

(57) ABSTRACT

An optical system for a vehicle may be configured with a plurality of camera sensors. Each camera sensor may be configured to create respective image data of a respective field of view. The optical system is further configured with a plurality of image processing units coupled to the plurality of camera sensors. The image processing units are configured to compress the image data captured by the camera sensors. A computing system is configured to store the compressed image data in a memory. The computing system is further configured with a vehicle-control processor configured to control the vehicle based on the compressed image data. The optical system and the computing system can be communicatively coupled by a data bus.

### CROSS REFERENCE TO RELATED APPLICATIONS

The present application is a continuation of U.S. patent application Ser. No. 16/214,589, filed Dec. 10, 2018, which claims priority to U.S. Provisional Patent Application Ser. No. 62/612,294, filed Dec. 29, 2017, the entirety of each of which is herein incorporated by reference.

### BACKGROUND

A vehicle could be any wheeled, powered vehicle and may include a car, truck, motorcycle, bus, etc. Vehicles can be utilized for various tasks such as transportation of people and goods, as well as many other uses.

Some vehicles may be partially or fully autonomous. For instance, when a vehicle is in an autonomous mode, some or all of the driving aspects of vehicle operation can be handled by an autonomous vehicle system (i.e., any one or more computer systems that individually or collectively function to facilitate control of the autonomous vehicle). In such cases, computing devices located onboard and/or in a server network could be operable to carry out functions such as planning a driving route, sensing aspects of the vehicle, sensing the environment of the vehicle, and controlling drive components such as steering, throttle, and brake. Thus, autonomous vehicles may reduce or eliminate the need for human interaction in various aspects of vehicle operation.

### SUMMARY

In one aspect, the present application describes an apparatus. The apparatus includes an optical system. The optical system may be configured with a plurality of camera sensors. Each camera sensor may be configured to create respective image data of a field of view of the respective camera sensor. The optical system is further configured with a plurality of image processing units coupled to the plurality of camera sensors. The image processing units are configured to compress the image data captured by the camera sensors. The apparatus is further configured to have a computing system. The computing system is configured with a memory configured to store the compressed image data. The computing system is further configured with a vehicle-control processor configured to control the apparatus based on the compressed image data. The optical system and the computing system of the apparatus are coupled by way of a data bus configured to communicate the compressed image data between the optical system and the computing system.

In another aspect, the present application describes a method of operating an optical system. The method includes providing light to a plurality of sensors of the optical system to create image data for each respective camera sensor. The image data corresponds to a field of view of the respective camera sensor. The method further includes compressing the image data by a plurality of image processing units coupled to the plurality of camera sensors. Additionally, the method includes communicating the compressed image data from the plurality of image processing units to a computing system. Yet further, the method includes storing the compressed image data in a memory of the computing system. Furthermore, the method includes controlling an apparatus based on the compressed image data by a vehicle-control processor of the computing system.

In still another aspect, the present application describes a vehicle. The vehicle includes a roof-mounted sensor unit. The roof-mounted sensor unit includes a first optical system configured with a first plurality of camera sensors. Each camera sensor of the first plurality of camera sensors creates respective image data of a field of view of the respective camera sensor. The roof-mounted sensor unit also includes a plurality of first image processing units coupled to the first plurality of camera sensors. The first image processing units are configured to compress the image data captured by the camera sensors. The vehicle also includes a second camera unit. The second camera unit includes second optical system configured with a second plurality of camera sensors. Each camera sensor of the second plurality of camera sensors creates respective image data of a field of view of the respective camera sensor. The second camera unit also includes a plurality of second image processing units coupled to the second plurality of camera sensors. The second image processing units are configured to compress the image data captured by the camera sensors of the second camera unit. The vehicle further includes a computing system located in the vehicle outside of the roof-mounted sensor unit. The computing system includes a memory configured to store the compressed image data. The computing system also includes a control system configured to operate the vehicle based on the compressed image data. Furthermore, the vehicle includes a data bus configured to communicate the compressed image data between the roof-mounted sensor unit, the second camera unit, and the computing system.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE DRAWINGS

FIG. 1 is a functional block diagram illustrating a vehicle, according to an example implementation.

FIG. 2 is a conceptual illustration of a physical configuration of a vehicle, according to an example implementation.

FIG. 3A is a conceptual illustration of wireless communication between various computing systems related to an autonomous vehicle, according to an example implementation.

FIG. 3B shows a simplified block diagram depicting example components of an example optical system.

FIG. 3C conceptual illustration of the operation of an optical system, according to an example implementation.

FIG. 4A illustrates an arrangement of image sensors, according to an example implementation.

FIG. 4B illustrates an arrangement of a platform, according to an example implementation.

FIG. 4C illustrates an arrangement of image sensors, according to an example implementation.

FIG. 5 is a flow chart of a method, according to an example implementation.

FIG. 6 is a schematic diagram of a computer program, according to an example implementation.

### DETAILED DESCRIPTION

Example methods and systems are described herein. It should be understood that the words “example,” “exemplary,” and “illustrative” are used herein to mean “serving as an example, instance, or illustration.” Any implementation or feature described herein as being an “example,” being “exemplary,” or being “illustrative” is not necessarily to be construed as preferred or advantageous over other implementations or features. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein. Additionally, in this disclosure, unless otherwise specified and/or unless the particular context clearly dictates otherwise, the terms “a” or “an” means at least one, and the term “the” means the at least one. Yet further, the term “enabled” may mean active and/or functional, not necessarily requiring an affirmative action to turn on. Similarly, the term “disabled” may mean non-active and/or non-functional, not necessarily requiring an affirmative action to turn off.

Furthermore, the particular arrangements shown in the figures should not be viewed as limiting. It should be understood that other implementations might include more or less of each element shown in a given Figure. Further, some of the illustrated elements may be combined or omitted. Yet further, an example implementation may include elements that are not illustrated in the Figures.

In practice, an autonomous vehicle system may use data representative of the vehicle's environment to identify objects. The vehicle system may then use the objects' identification as a basis for performing another action, such as instructing the vehicle to act in a certain way. For instance, if the object is a stop sign, the vehicle system may instruct the vehicle to slow down and stop before the stop sign, or if the object is a pedestrian in the middle of the road, the vehicle system may instruct the vehicle to avoid the pedestrian.

In some scenarios, a vehicle may use an imaging system having a plurality of optical cameras to image the environment around the vehicle. The imaging of the environment may be used for object identification and/or navigation. The imaging system may use many optical cameras, each having an image sensor (i.e., light sensor and/or camera), such as a Complementary Metal-Oxide-Semiconductor (CMOS) image sensor. Each CMOS sensor may be configured to sample incoming light and create image data of a field of the respective sensor. Each sensor may create images at a predetermined rate. For example, an image sensor may capture images at 30 or 60 images per second, or image capture may be triggered, potentially repeatedly, by an external sensor or event. The plurality of captured images may form a video.

In some examples, the vehicle may include a plurality of cameras. In one example, the vehicle may include 19 cameras. In a 19-camera setup, 16 of the cameras may be mounted in a sensor dome, with the three other cameras mounted to the main vehicle. The three cameras that are not in the dome may be configured with a forward-looking direction. The 16 cameras in the sensor dome may be arranged as eight camera (i.e., sensor) pairs. The eight sensor pairs may be mounted in a circular ring. In one example, the sensor pair may be mounted with a 45-degree separation between each sensor pair, however other angular separations may be used too (in some examples, the sensors may be configured to have an angular separation that causes an overlap of the field of view of the sensor). Additionally, in some examples, the circular ring and attached camera units may be configured to rotate in a circle. When the circular ring rotates, the cameras may each be able to image the full 360-degree environment of the vehicle.

In some examples, each camera captures images at the same image rate and at the same resolution as the other cameras. In other examples, the cameras may capture images at different rates and resolutions. In practice, the three forward looking cameras may capture images at a higher resolution and at a higher frame rate than the cameras that are part of the ring of cameras.

In one example, the two cameras that make up camera pair may be two cameras that are configured to have a similar field of view, but with different dynamic ranges corresponding to different ranges of luminance levels. By having different dynamic ranges, one camera may be more effective at capturing images (e.g. exposing light to the sensor) having high intensity light and the other camera may be more effective at capturing images having low intensity light. For example, some objects may appear bright, like a car's headlights at night, and others may appear dim, such as a jogger wearing all black at night. For autonomous operation of a vehicle, it may be desirable to be able to image both the lights of the oncoming car and the jogger. A single camera may be unable to image both simultaneously due to the large differences in light levels. However, a camera pair may include a first camera with a first dynamic range that can image high light levels (such as the car's headlights) and a second camera with a second dynamic rang that can image low light levels (such as the jogger wearing all black). Other examples are possible as well. Additionally, the cameras of the present application may be similar to, or the same as, those disclosed in U.S. Provisional Patent Application Ser. No. 62/611,194, filed on Dec. 28, 2017, the entire contents of which is herein incorporated by reference.

Because each of the 19 cameras is capturing images at a fixed frame rate, the amount of data captured by the system may be very large. For example, if each image captured is 10 megapixels, each uncompressed image may be approximately 10 megabytes in size (in other examples, the file size may be different depending on various factors, such as image resolution, bit depth, compression, etc.). If there are 19 cameras, each capturing a 10-megabyte image 60 times a second, the full camera system may be capturing about 11.5 gigabytes of image data per second. The amount of data captured by the camera system may not be practical to store and route to various processing components of the vehicle. Therefore, the system may use image processing and/or compression in order to reduce the data usage of the imaging system.

To reduce the data usage of the imaging system, the image sensors may be coupled to one or more dedicated processors that are configured to do image processing. The image processing may include image compression. Further, in order to reduce the computational and memory needs of the system, the image data may be compressed by an image processor located near the image sensor, before the image data is routed for further processing.

The presently-disclosed processing may be performed by way of color sensing of processing. Color sensing of processing may use the full visible color spectrum, a subset of the visible color spectrum, and/or parts of the color spectrum that are outside the human-visible range (e.g. infrared and/or ultraviolet). Many traditional image processing systems may operate only using black and white, and/or a narrow color space (i.e. operating on images having a colored filter, such as a red filter). By using color sensing of processing, more accurate color representations may be used for object sensing, object detection, and reconstruction of image data.

In some examples, a predetermined number of successive images from a given image sensor may be compressed by maintaining only one of the images and extracting data related to motion of objects from the remaining images that are not maintained. For example, for each set of six successive images, one of the images may be saved and the remaining five images may only have their associated motion data saved. In other examples, the predetermined number of images may be different than six. In some other examples, the system may dynamically alter the number of images based on various criteria.

In yet another example, the system may store a reference image and only store data comprising changes relative to the reference image for other images. In some examples, a new reference image may be stored after a predetermined number of images, or after a threshold level of change from the reference image. For example, the predetermined number of images may be altered based on weather or environment conditions. In other examples, the predetermined number of images may be altered based on a number and/or location of detected objects. Additionally, the image processor may also perform some compression on the image that is saved, further reducing the data requirements of the system.

To increase system performance, it may be desirable to process images captured by the sensors in a sensor pair simultaneously, or near simultaneously. In order to process the images as near as simultaneously as possible, it may be desirable to route the image and/or video captured by each sensor of the sensor pair to a different respective image processor. Therefore, the two images captured by the sensor pair may be processed simultaneously, or near simultaneously, by two different image processors. In some examples, the image processor may be located in close physical proximity to the image sensors. For example, there may be four image processors located in the sensor dome of the vehicle. In another example, there may be an image processor colocated with the image sensors that are located under a windshield of a vehicle. In this example, one or two image processors may be located near the forward-looking image sensors.

In practice, the electrical distance (i.e. the distance as measured along the electrical traces) between the image sensors and the image processors may be on the order of a few inches. In one example, the image sensors and the image processors that perform the first image compression are located within 6 inches of each other.

There are many benefits to having the image sensors and the image processors located near each other. One benefit is system latency may be reduced. The image data may be quickly processed and/or compressed near the sensor before being communicated to a vehicle-control system. This may enable the vehicle-control system to not have to wait as long to acquire data. Second, by having the image sensors and the image processors located near each other data may be communicated more effectively by way of a data bus of the vehicle.

The image processors may be coupled to a data bus of the vehicle. The data bus may communicate the processed image data to another computing system of the vehicle. For example, the image data may be used by a processing system that is configured to control the operation of the autonomous vehicle. The data bus may operate over an optical, coaxial, and or twisted pair communication pathway. The bandwidth of the data bus may be sufficient to communicate the processed image data with some overhead for additional communication. However, the data bus may not have enough bandwidth to communicate all the captured image data if the image data was not processed. Therefore, the present system may be able to take advantage of information captured by a high-quality camera system without the processing and data movement requirements of a traditional image processing system.

The present system may operate with one or more cameras having a higher resolution than conventional vehiclular camera systems. Due to having a higher camera resolution, it may be desirable in some examples for the present system to incorporate some signal processing to offset some undesirable effects that may manifest in higher resolution images that the presently-disclosed system may produces. In some examples, the present system may measure line of sight jitter and/or a pixel smear analysis. The measurements may be calculated in terms of a milliradian per pixel distortion. An analysis of these distortions may enable processing to offset or mitigate the undesirable effects. Additionally, the system may experience some image blur that may be caused by wobbling or vibrating of the camera platform. Blur reduction and/or image stabilization techniques may be used to minimize the blur. Because the present camera systems are generally higher resolution than conventional vehicular camera systems, many traditional systems have not had to offset these potential negative effects, as camera resolutions may be too low to notice the effects.

Additionally, the presently disclosed camera system may use multiple cameras of varying resolution. In one example, the previously-discussed camera pairs (i.e. sensor pair) may have a first resolution and a first field-of-view angular width. The system may also include at least one camera mounted under the windshield of the vehicle, such as behind a location of the rear-view mirror, in a forward-looking direction. In some examples, the cameras located behind the rear-view mirror may include a camera pair having the first resolution and the first field-of-view angular width. The cameras located behind the windshield may include a third camera having a resolution greater than the first resolution and a field-of-view angular width greater than the first field-of-view angular width. In some examples, there may only be the higher-resolution wider-angular-view camera behind the windshield. Other examples are possible too.

This camera system having the higher-resolution wider-angular-view camera behind the windshield may allows a 3rd degree of freedom with the dynamic range of the camera system as a whole. Additionally, the introduction of the higher-resolution wider-angular-view camera behind the windshield also provides other benefits, such as having the ability to image the region of the seam formed by the angularly-separated camera sensors. Additionally, the higher-resolution wider-angular-view camera allows a continuous detection capability out quite far and/or with long focal length lenses, which can see the stop sign at a distance. This same camera sensor may struggle to image a stop sign near due to the sheer size of the sign and the field of view. By combining cameras with different specifications (e.g. resolution and angular field-of-view) and locations (mounting locations and field-of-view) the system may provide further benefits over conventional systems.

Example systems within the scope of the present disclosure will now be described in greater detail. An example system may be implemented in or may take the form of an automobile. However, an example system may also be implemented in or take the form of other vehicles, such as cars, trucks, motorcycles, buses, boats, airplanes, helicopters, lawn mowers, earth movers, boats, snowmobiles, aircraft, recreational vehicles, amusement park vehicles, farm equipment, construction equipment, trams, golf carts, trains, trolleys, and robot devices. Other vehicles are possible as well

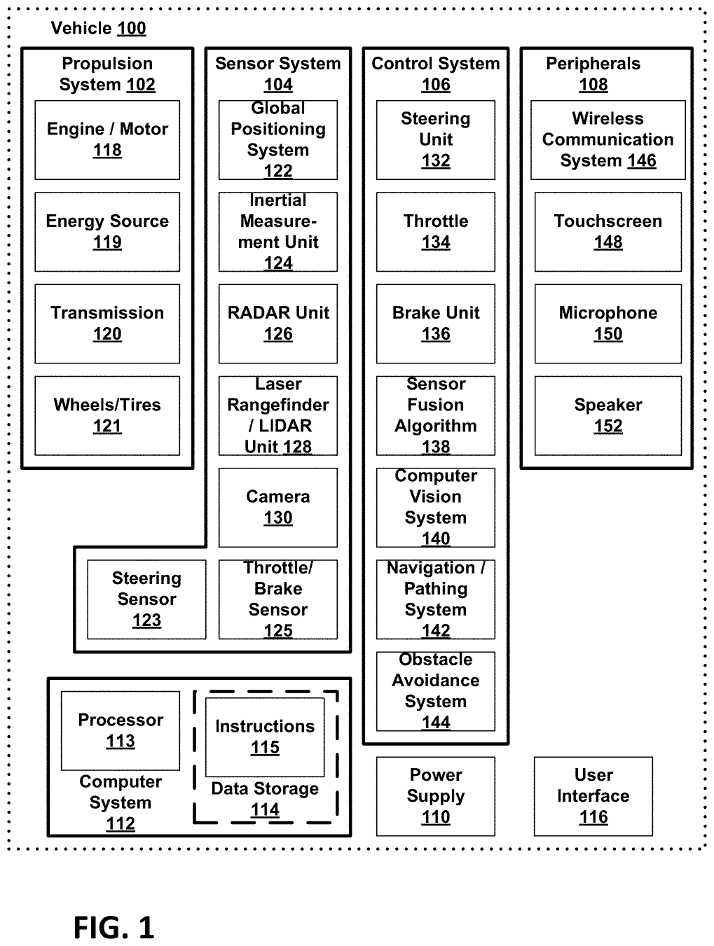

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. In some implementations, vehicle 100 may also include subsystems that enable a driver to control operations of vehicle 100.

As shown in FIG. 1, vehicle 100 may include various subsystems, such as propulsion system 102, sensor system 104, control system 106, one or more peripherals 108, power supply 110, computer system 112, data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within implementations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some implementations, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118). For instance, energy source 119 can correspond to gasoline, diesel, other petroleum-based fuels, propane, other compressed gas-based fuels, ethanol, solar panels, batteries, and/or other sources of electrical power. In some implementations, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example implementations. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, laser rangefinder/LIDAR 128, camera 130, steering sensor 123, and throttle/brake sensor 125, among other possible sensors. In some implementations, sensor system 104 may also include sensors configured to monitor internal systems of the vehicle 100 (e.g., 02 monitor, fuel gauge, engine oil temperature, brake wear).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the local environment of vehicle 100. As such, radar 126 may include antennas configured to transmit and receive radio signals. In some implementations, radar 126 may correspond to a mountable radar system configured to obtain measurements of the surrounding environment of vehicle 100.

Laser rangefinder/LIDAR 128 may include one or more laser sources, a laser scanner, and one or more detectors, among other system components, and may operate in a coherent mode (e.g., using heterodyne detection) or in an incoherent detection mode. Camera 130 may include one or more devices (e.g., still camera or video camera) configured to capture images of the environment of vehicle 100. The camera 130 may include multiple camera units positioned throughout the vehicle. The camera 130 may include camera units positioned in a top dome of the vehicle and/or camera units located within the body of the vehicle, such as cameras mounted near the windshield.

Steering sensor 123 may sense a steering angle of vehicle 100, which may involve measuring an angle of the steering wheel or measuring an electrical signal representative of the angle of the steering wheel. In some implementations, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve or carburetor). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other implementations, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some implementations, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some implementations, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software operable to process and analyze images in an effort to determine objects, environmental objects (e.g., stop lights, road way boundaries, etc.), and obstacles. As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as CDMA, EVDO, GSM/GPRS, or 4G cellular communication, such as WiMAX or LTE. Alternatively, wireless communication system 146 may communicate with a wireless local area network (WLAN) using WiFi or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some implementations. For instance, power supply 110 may include one or more batteries configured to provide electrical power. Vehicle 100 may also use other types of power supplies. In an example implementation, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory computer readable medium, such as data storage 114. In some implementations, computer system 112 may represent a plurality of computing devices that may serve to control individual components or subsystems of vehicle 100 in a distributed fashion.

In some implementations, data storage 114 may contain instructions 115 (e.g., program logic) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, and control system 106), as well as from user interface 116. For example, computer system 112 may utilize input from sensor system 104 in order to estimate the output produced by propulsion system 102 and control system 106. Depending upon the implementation, computer system 112 could be operable to monitor many aspects of vehicle 100 and its subsystems. In some implementations, computer system 112 may disable some or all functions of the vehicle 100 based on signals received from sensor system 104.

The components of vehicle 100 could be configured to work in an interconnected fashion with other components within or outside their respective systems. For instance, in an example implementation, camera 130 could capture a plurality of images that could represent information about a state of an environment of vehicle 100 operating in an autonomous mode. The state of the environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar unit 126 may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some implementations, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100, i.e., wireless communication system 146, computer system 112, data storage 114, and user interface 116, as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

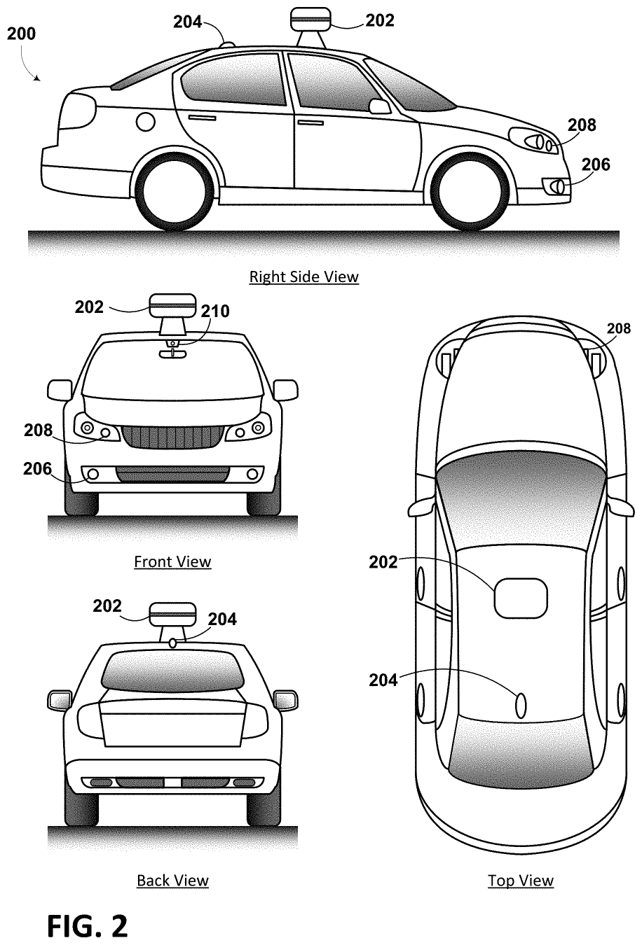

FIG. 2 depicts an example physical configuration of vehicle 200, which may represent one possible physical configuration of vehicle 100 described in reference to FIG. 1. Depending on the implementation, vehicle 200 may include sensor unit 202, wireless communication system 204, radio unit 206, deflectors 208, and camera 210, among other possible components. For instance, vehicle 200 may include some or all of the elements of components described in FIG. 1. Although vehicle 200 is depicted in FIG. 2 as a car, vehicle 200 can have other configurations within examples, such as a truck, a van, a semi-trailer truck, a motorcycle, a golf cart, an off-road vehicle, or a farm vehicle, among other possible examples.

Sensor unit 202 may include one or more sensors configured to capture information of the surrounding environment of vehicle 200. For example, sensor unit 202 may include any combination of cameras, radars, LIDARs, range finders, radio devices (e.g., Bluetooth and/or 802.11), and acoustic sensors, among other possible types of sensors. In some implementations, sensor unit 202 may include one or more movable mounts operable to adjust the orientation of sensors in sensor unit 202. For example, the movable mount may include a rotating platform that can scan sensors so as to obtain information from each direction around the vehicle 200. The movable mount of sensor unit 202 may also be movable in a scanning fashion within a particular range of angles and/or azimuths.

In some implementations, sensor unit 202 may include mechanical structures that enable sensor unit 202 to be mounted atop the roof of a car. Additionally, other mounting locations are possible within examples.

Wireless communication system 204 may have a location relative to vehicle 200 as depicted in FIG. 2, but can also have different locations within implementations. Wireless communication system 200 may include one or more wireless transmitters and one or more receivers that may communicate with other external or internal devices. For example, wireless communication system 204 may include one or more transceivers for communicating with a user's device, other vehicles, and roadway elements (e.g., signs, traffic signals), among other possible entities. As such, vehicle 200 may include one or more vehicular communication systems for facilitating communications, such as dedicated short-range communications (DSRC), radio frequency identification (RFID), and other proposed communication standards directed towards intelligent transport systems.

Camera 210 may have various positions relative to vehicle 200, such as a location on a front windshield of vehicle 200. As such, camera 210 may capture images of the environment of vehicle 200. As illustrated in FIG. 2, camera 210 may capture images from a forward-looking view with respect to vehicle 200, but other mounting locations (including movable mounts) and viewing angles of camera 210 are possible within implementations. In some examples, camera 210 may correspond to one or more visible light cameras. Alternatively or additionally, camera 210 may include infrared sensing capabilities. Camera 210 may also include optics that may provide an adjustable field of view.

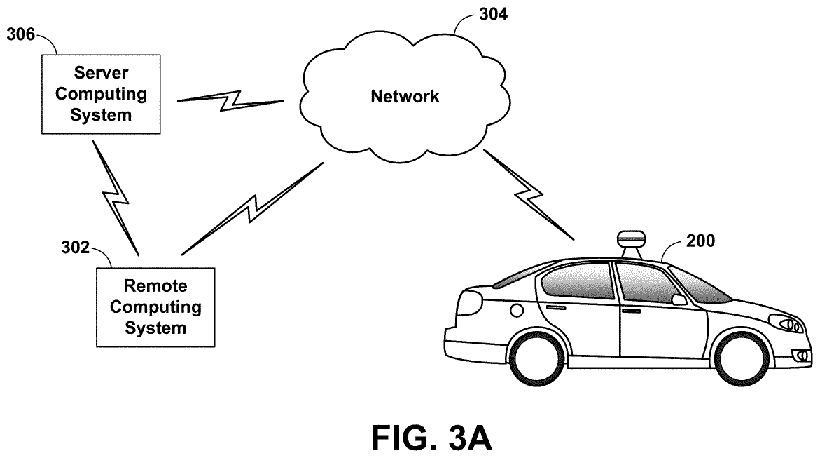

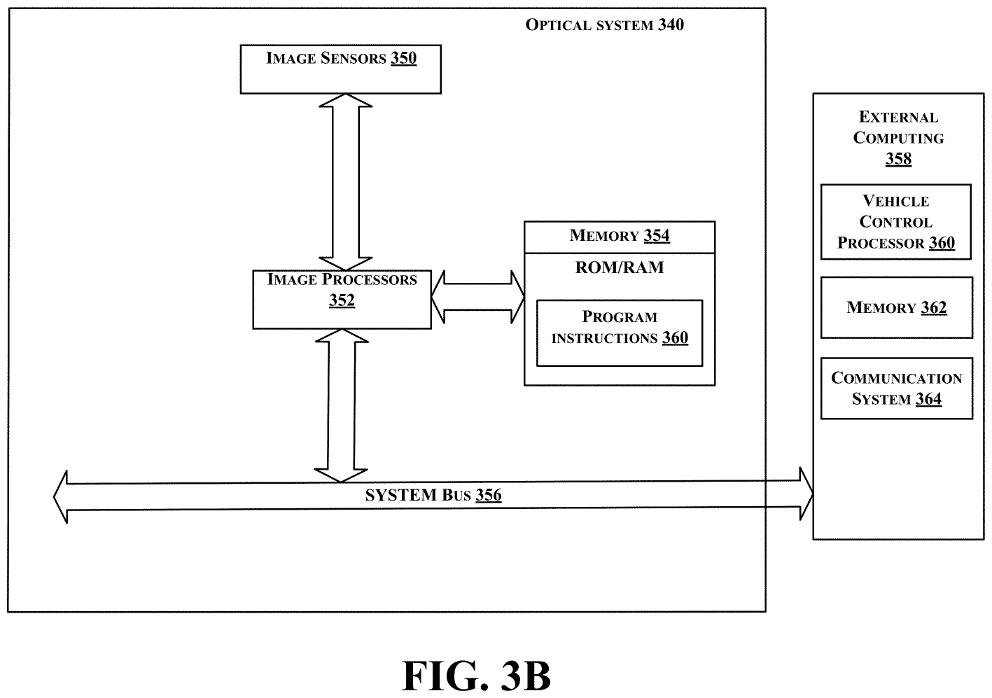

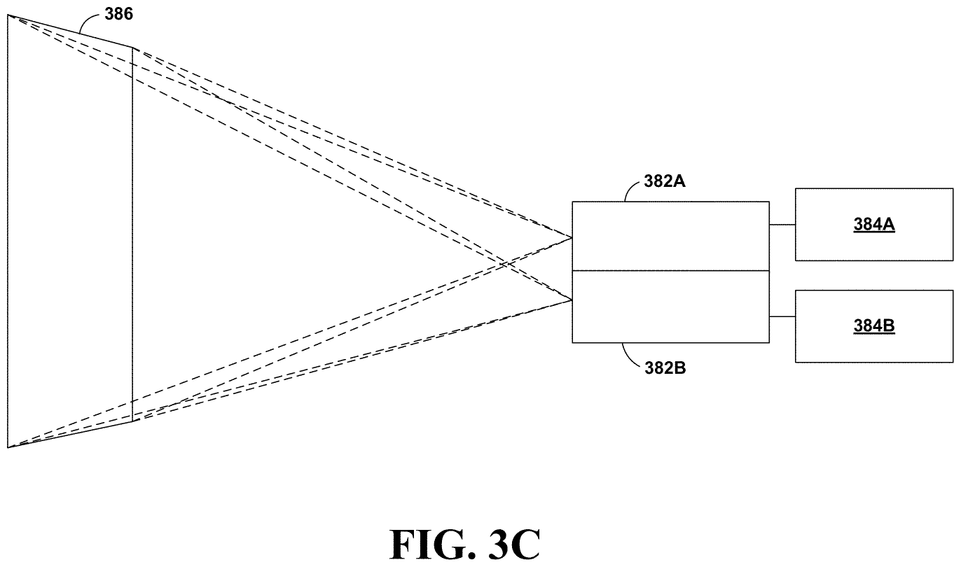

FIG. 3A is a conceptual illustration of wireless communication between various computing systems related to an autonomous vehicle, according to an example implementation. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous mode that enables a control system to safely navigate vehicle 200 between destinations using sensor measurements. When operating in an autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some implementations, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has a wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some implementations, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some implementations of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, or perhaps server computing system 306, or a computing system local to vehicle 200) may operate to use a camera to capture images of the environment of an autonomous vehicle. In general, at least one computing system will be able to analyze the images and possibly control the autonomous vehicle.

In some implementations, to facilitate autonomous operation a vehicle (e.g., vehicle 200) may receive data representing objects in an environment in which the vehicle operates (also referred to herein as “environment data”) in a variety of ways. A sensor system on the vehicle may provide the environment data representing objects of the environment. For example, the vehicle may have various sensors, including a camera, a radar unit, a laser range finder, a microphone, a radio unit, and other sensors. Each of these sensors may communicate environment data to a processor in the vehicle about information each respective sensor receives.

In one example, a camera may be configured to capture still images and/or video. In some implementations, the vehicle may have more than one camera positioned in different orientations. Also, in some implementations, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar unit may be configured to transmit an electromagnetic signal that will be reflected by various objects near the vehicle, and then capture electromagnetic signals that reflect off the objects. The captured reflected electromagnetic signals may enable the radar system (or processing system) to make various determinations about objects that reflected the electromagnetic signal. For example, the distance and position to various reflecting objects may be determined. In some implementations, the vehicle may have more than one radar in different orientations. The radar system may be configured to store captured information to a memory for later processing by a processing system of the vehicle. The information captured by the radar system may be environment data.

In another example, a laser range finder may be configured to transmit an electromagnetic signal (e.g., light, such as that from a gas or diode laser, or other possible light source) that will be reflected by a target objects near the vehicle. The laser range finder may be able to capture the reflected electromagnetic (e.g., laser) signals. The captured reflected electromagnetic signals may enable the range-finding system (or processing system) to determine a range to various objects. The range-finding system may also be able to determine a velocity or speed of target objects and store it as environment data.

Additionally, in an example, a microphone may be configured to capture audio of environment surrounding the vehicle. Sounds captured by the microphone may include emergency vehicle sirens and the sounds of other vehicles. For example, the microphone may capture the sound of the siren of an emergency vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some implementations it is desirable to transmit the first electromagnetic radiation signal with a signaling mode that requests a response from devices located near the autonomous vehicle. The processing system may be able to detect nearby devices based on the responses communicated back to the radio unit and use this communicated information as a portion of the environment data.

In some implementations, the processing system may be able to combine information from the various sensors in order to make further determinations of the environment of the vehicle. For example, the processing system may combine data from both radar information and a captured image to determine if another vehicle or pedestrian is in front of the autonomous vehicle. In other implementations, other combinations of sensor data may be used by the processing system to make determinations about the environment.

While operating in an autonomous mode, the vehicle may control its operation with little-to-no human input. For example, a human-operator may enter an address into the vehicle and the vehicle may then be able to drive, without further input from the human (e.g., the human does not have to steer or touch the brake/gas pedals), to the specified destination. Further, while the vehicle is operating autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the environment (e.g., if there is actually a stop sign or if there is actually no stop sign present), (ii) confirm whether the vehicle's identification of the object is correct, (iii) correct the identification if the identification was incorrect and/or (iv) provide a supplemental instruction (or modify a present instruction) for the autonomous vehicle. Remote assistance tasks may also include the human operator providing an instruction to control operation of the vehicle (e.g., instruct the vehicle to stop at a stop sign if the human operator determines that the object is a stop sign), although in some scenarios, the vehicle itself may control its own operation based on the human operator's feedback related to the identification of the object.

The vehicle may detect objects of the environment in various way depending on the source of the environment data. In some implementations, the environment data may come from a camera and be image or video data. In other implementations, the environment data may come from a LIDAR unit. The vehicle may analyze the captured image or video data to identify objects in the image or video data. The methods and apparatuses may be configured to monitor image and/or video data for the presence of objects of the environment. In other implementations, the environment data may be radar, audio, or other data. The vehicle may be configured to identify objects of the environment based on the radar, audio, or other data.

In some implementations, the techniques the vehicle uses to detect objects may be based on a set of known data. For example, data related to environmental objects may be stored to a memory located in the vehicle. The vehicle may compare received data to the stored data to determine objects. In other implementations, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other implementations, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some implementations, the vehicle may react as if the detected object is present despite the low confidence level. In other implementations, the vehicle may react as if the detected object is not present.

When the vehicle detects an object of the environment, it may also calculate a confidence associated with the specific detected object. The confidence may be calculated in various ways depending on the implementation. In one example, when detecting objects of the environment, the vehicle may compare environment data to predetermined data relating to known objects. The closer the match between the environment data to the predetermined data, the higher the confidence. In other implementations, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object.

In some implementations, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of vehicle (e.g., a speed and/or direction), among other possible adjustments.

In other implementations, even if the vehicle detects an object having a confidence that meets or exceeds the threshold, the vehicle may operate in accordance with the detected object (e.g., come to a stop if the object is identified with high confidence as a stop sign), but may be configured to request remote assistance at the same time as (or at a later time from) when the vehicle operates in accordance with the detected object.

FIG. 3B shows a simplified block diagram depicting example components of an example optical system 340. This example optical system 340 could correspond to optical system of an autonomous vehicle as described herein. In some examples, the vehicle may include more than one optical system 340. For example, a vehicle may include one optical system mounted to a top of the vehicle in a sensor dome and another optical system located behind the windshield of the vehicle. In other examples, the various optical system may be located in various different positions throughout the vehicle.

Optical system 340 may include one or more image sensors 350, one or more image processors 352, and memory 354. Depending on the desired configuration, the image processor(s) 352 can be any type of processor including, but not limited to, a microprocessor (μP), a microcontroller (μC), a digital signal processor (DSP), graphics processing unit (GPU), system on a chip (SOC), or any combination thereof. An SOC may combine a traditional microprocessor, GPU, a video encoder/decoder, and other computing components. Furthermore, memory 354 can be of any type of memory now known or later developed including but not limited to volatile memory (such as RAM), non-volatile memory (such as ROM, flash memory, etc.) or any combination thereof. In some examples, the memory 354 may be a memory cache to temporarily store image data. In some examples, the memory 354 may be integrated as a portion of a SOC that forms image processor 352.

In an example embodiment, optical system 340 may include a system bus 356 that communicatively couples the image processor(s) 352 with an external computing device 358. The external computing device 358 may include a vehicle-control processor 360, memory 362, communication system 364, and other components. Additionally, the external computing device 358 may be located in the vehicle itself, but as a separate system from the optical system 340. The communication system 364 be configured to communicate data between the vehicle and a remote computer server. Additionally, the external computing device 358 may be used for longer term storage and/or processing of images. The external computing device 358 may be configured with a larger memory than memory 354 of the optical system 340. For example, image data in the external computing device 358 may be used by a navigation system (e.g. navigation processor) of the autonomous vehicle.

An example optical system 340 includes a plurality of image sensors 350. In one example, the optical system 340 may include 16 image sensors as image sensors 350 and four image processors 352. The image sensors 350 may be mounted in a roof-mounted sensor dome. The 16 image sensors may be arranged as eight sensor pairs. The sensor pairs may be mounted on a camera ring where each sensor pair is mounted 45 degrees from adjacent sensor pairs. In some examples, during the operation of the sensor unit, the sensor ring may be configured to rotate.

The image sensors 350 may be coupled to the image processors 352 as described herein. Of each sensor pair, each sensor may be coupled to a different image processor 352. By coupling each sensor to a different image processor, the images captured by a respective sensor pair may be processed simultaneously (or near simultaneously). In some examples, the image sensors 350 may all be coupled to all of the image processors 352. The routing of the images from an image sensor to a respective image processor may be controlled by software rather than exclusively by a physical connection. In some examples, both the image sensors 350 and the image processors 352 may be located in a sensor dome of the vehicle. In some additional examples, the image sensors 350 maybe located near the image processors 352. For example, the electrical distance (i.e. the distance as measured along the electrical traces) between the image sensors 350 and the image processors 352 may be on the order of a few inches. In one example, the image sensors 350 and the image processors 352 that perform the first image compression are located within 6 inches of each other.

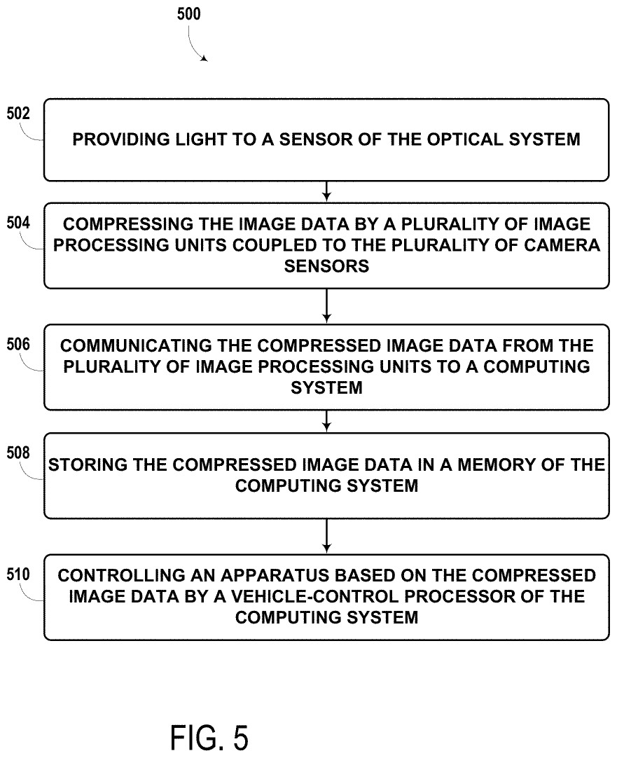

According to an example embodiment, optical system 340 may include program instructions 360 that are stored in memory 354 (and/or possibly in another data-storage medium) and executable by image processor 352 to facilitate the various functions described herein including, but not limited to, those functions described with respect to FIG. 5. For example, image and/or video compression algorithms may be stored in the memory 354 and executed by the image processor 352. Although various components of optical system 340 are shown as distributed components, it should be understood that any of such components may be physically integrated and/or distributed according to the desired configuration of the computing system.

FIG. 3C is a conceptual illustration of the operation of an optical system having two cameras 382A and 382B arranged in a camera pair and two image processors 384A and 384B. In this example, the two cameras 382A and 382B have the same field of view (e.g., a common field of view 386). In other examples, the two cameras 382A and 382B may have fields of view that are similar but not the same (e.g., overlapping fields of view). In still other examples, the two cameras 382A and 382B may have entirely different (e.g., non-overlapping) fields of view. As previously discussed, the two image processors 384A and 384B may be configured to process the two images captured by the sensor pair simultaneously, or near simultaneously. By routing the images created by the two sensors to two different processors, the images may be processed in parallel. Had the images be routed to a single processor, the images may have been processed in series (i.e., sequentially).

In some examples, the two cameras 382A and 382B may be configured with different exposures. One of the two cameras may be configured to operate with high amounts of light and the other camera may be configured to operate with low levels of light. When both cameras take an image of a scene (i.e., take images of a similar field of view), some objects may appear bright, like a car's headlights at night, and others may appear dim, such as a jogger wearing all black at night. For autonomous operation of a vehicle, it may be desirable to be able to image both the lights of the oncoming car and the jogger. A single camera may be unable to image both due to the large differences in light levels. However, a camera pair may include a first camera with a first dynamic range that can image high light levels (such as the car's headlights) and a second camera with a second dynamic rang that can image low light levels (such as the jogger wearing all black). Other examples are possible as well.

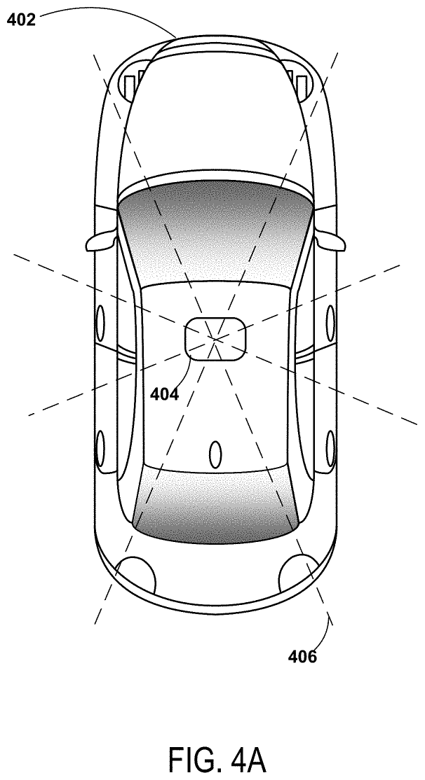

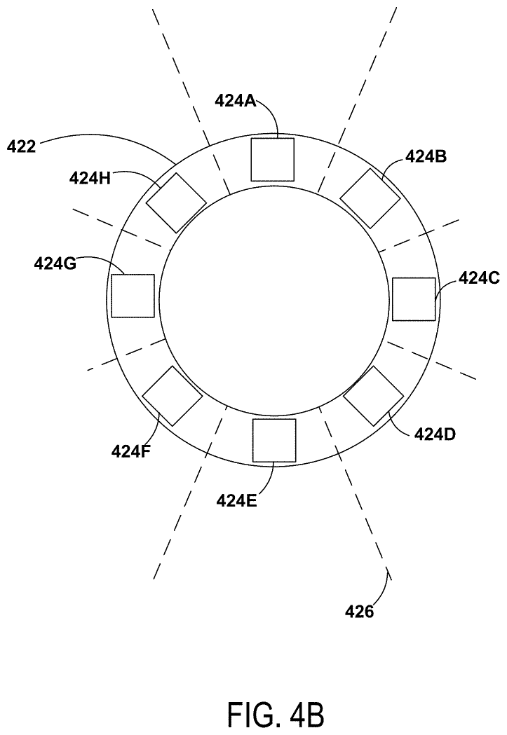

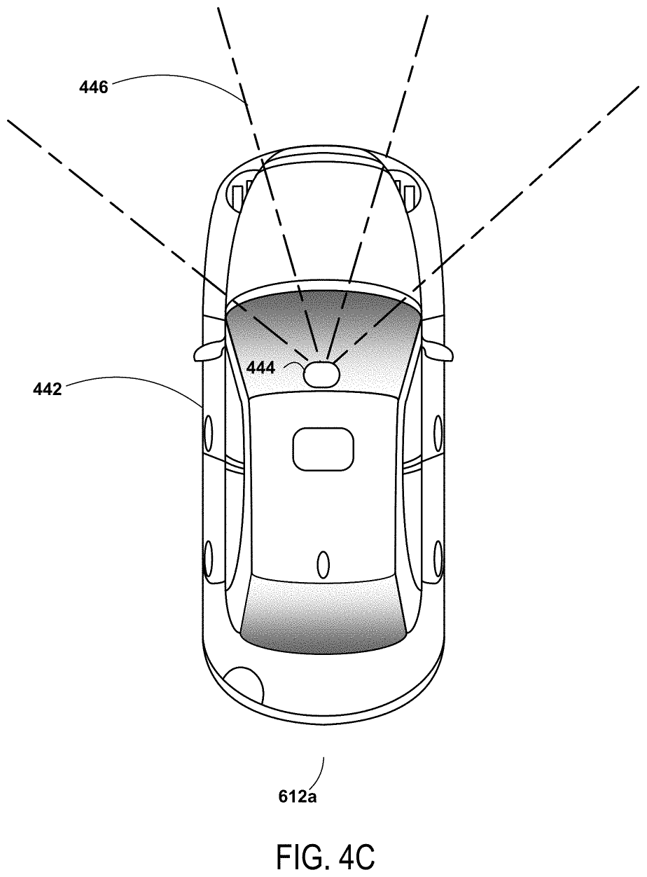

FIG. 4A illustrates an arrangement of image sensors of a vehicle 402. As previously discussed, a roof-mounted sensor unit 404 may contain eight sensor pairs of cameras that are mounted with a 45-degree separation from the adjacent sensor pair. Further, the sensor pairs may be mounted on a rotational platform and/or a gimbaled platform. FIG. 4A shows the vehicle 402 and the associated field of views 406 for each of the eight sensor pairs. As shown in FIG. 4A, each sensor pair may have approximately a 45-degree field of view. Therefore, the full set of eight sensor pairs may be able to image a full 360-degree region around the vehicle. In some examples, the sensor pairs may have a field of view that is wider than 45-degrees. If the sensors have a wider field of view, the regions imaged by the sensors may overlap. In examples where the fields of view of the sensors overlap, the lines shown as field of views 406 of FIG. 4A may be an approximation of the center of the overlapping portion of the fields of view.

FIG. 4B illustrates an arrangement of a ring 422 that has eight sensor pairs 424A-424H mounted at 45-degrees with respect to the adjacent sensor. The sensor ring may be located in the roof-mounted sensor unit of the vehicle.

FIG. 4C illustrates an arrangement of image sensors. The vehicle 442 of FIG. 4C may have a sensor unit 444 mounted behind the windshield, for example near a rear-view mirror of the vehicle 442 (such as a centered location at the top of the windshield, facing the direction of travel of the vehicle). An example image sensor 444 may include three image sensors configured to image a forward-looking view from the vehicle 442. The three forward-looking sensors of the sensor unit 444 may have associated fields of view 446 as indicated by the dashed lines of FIG. 4C. Similar to as discussed with respect to FIG. 4A, the sensors may have fields of view that overlap and the lines shown as field of views 446 of FIG. 4C may be an approximation of the center of the overlapping portion of the fields of view.

In some examples, a vehicle may include both the sensors of FIGS. 4A, 4B, and 4C. Therefore, the overall field of view of the sensors of this example vehicle would be those shown across FIGS. 4A, 4B, and 4C.

As previously discussed, in another example, the cameras of image sensor 444 located behind the rear-view mirror may include a camera pair having the first resolution and the first field-of-view angular width. The cameras located behind the windshield may include a third camera having a resolution greater than the first resolution and a field-of-view angular width greater than the first field-of-view angular width. For example, the narrow field of view of field of view 446 may be for the camera pair and the wide field of view of field of view 446 may be fore the higher-resolution camera. In some examples, there may only be the higher-resolution wider-angular-view camera behind the windshield.

FIG. 5 is a flow chart of a method 500, according to an example implementation.

Method 500 represents an example method that may include one or more operations as depicted by one or more of blocks 502-510, each of which may be carried out by any of the systems shown in FIGS. 1-4B, among other possible systems. In an example implementation, a computing system such as optical system 350 in conjunction with external computing device 358 performs the illustrated operations, although in other implementations, one or more other systems (e.g., server computing system 306) can perform some or all of the operations.

Those skilled in the art will understand that the flowcharts described herein illustrates functionality and operations of certain implementations of the present disclosure. In this regard, each block of the flowcharts may represent a module, a segment, or a portion of program code, which includes one or more instructions executable by one or more processors for implementing specific logical functions or steps in the processes. The program code may be stored on any type of computer readable medium, for example, such as a storage device including a disk or hard drive. In some examples, a portion of the program code may be stored in a SOC as previously described.

In addition, each block may represent circuitry that is wired to perform the specific logical functions in the processes. Alternative implementations are included within the scope of the example implementations of the present application in which functions may be executed out of order from that shown or discussed, including substantially concurrent or in reverse order, depending on the functionality involved, as would be understood by those reasonably skilled in the art. Within examples, any system may cause another system to perform one or more of the operations (or portions of the operations) described below.

In line with the discussion above, a computing system (e.g., optical system 350, external computing device 358, remote computing system 302, or server computing system 306) may operate as shown by method 500. As shown in FIG. 5, at block 502, the system operates by providing light to a plurality of sensors of the optical system to create image data for each respective camera sensor. The image data corresponds to a field of view of the respective camera sensor.

As previously discussed a vehicle may have a plurality of sensors configured to receive light. In some examples, a vehicle may include 19 camera sensors. The sensors may be arranged with 16 sensors forming eight camera pairs of a camera unit located in a top mounted sensor unit and three sensors forming a camera unit located behind the windshield of a vehicle. The camera pairs may be configured with two cameras, each having a different exposure. By having two cameras with different exposures, the cameras may be able to more accurately image both bright and dark areas of a field of view. Other possible arrangements of camera sensors are possible as well.

During the operation of the vehicle, each sensor may receive light from the field of view of the respective sensor. The sensors may capture images at a predetermined rate. For example, an image sensor may capture images at 30 or 60 images per second, or image capture may be triggered, potentially repeatedly, by an external sensor or event. The plurality of captured images may form a video.

At block 504, the system operates by compressing the image data by a plurality of image processing units coupled to the plurality of camera sensors. As previously discussed, because each of the 19 cameras is capturing images at a fixed frame rate, the amount of data captured by the system may be very large. In one example, if each image captured is 10 megapixels, each uncompressed image is approximately 10 megabytes in size. If there are 19 cameras, each capturing a 10-megabyte image 60 times a second, the full camera system may be capturing about 11.5 gigabytes of image data per second. Depending on the parameters of the image capture system, such as image resolution, bit depth, compression, etc., the size of an image may vary. In some examples, an image file may be much larger than 10 megabytes. The amount of data captured by the camera system may not be practical to store and route to various processing components of the vehicle. Therefore, the system may include some image processing and/or compression in order to reduce the data usage of the imaging system.

To reduce the data usage of the imaging system, the image sensors may be coupled to a processor configured to do image processing. The image processing may include image compression. Because of large amount of data, storage, processing, and moving data may be computationally and memory intensive. In order to reduce the computational and memory needs of the system, the image data may be compressed by an image processor located near the image sensor, before the image data is routed for further processing.

In some examples, the image processing may include, for each image sensor, storing one of a predetermined number of images captured by the camera. For the remaining images that are not stored, the image processor may drop the images and only store data related to the motion of objects within the image. In practice, the predetermined number of images may be six, thus one of every six images may be saved and the remaining five images may only have their associated motion data saved. Additionally, the image processor may also perform some compression on the image that is saved, further reducing the data requirements of the system.

Therefore after compression, there is a reduction in the number of stored images by a factor equal to the predetermined rate. For the images that are not stored, motion data of the objects detected in the image is stored. Further, the image that is stored may also be compressed. In some examples, the image may be compressed in a manner that enables detection of objects in the compressed image.

To increase system performance, it may be desirable to process images received by sensor pair simultaneously, or near simultaneously. In order to process the images as near as simultaneously as possible, it may be desirable to route the image captured by each sensor of the sensor pair to a different respective image processor. Therefore, the two images captured by the sensor pair may be processed simultaneously, or near simultaneously, by two different image processors. In some examples, the image processor may be located in close physical proximity to the image sensors. For example, there may be four image processors located in the sensor dome of the vehicle. Additionally, one or two image processors may be located near the forward-looking image sensors.

At block 506 the system operates by communicating the compressed image data from the plurality of image processing units to a computing system. The image processors may be coupled to a data bus of the vehicle. The data bus may communicate the processed image data to another computing system of the vehicle. For example, the image data may be used by a processing system that is configured to control the operation of the autonomous vehicle. The data bus may operate over an optical, coaxial, and or twisted pair communication pathway. The bandwidth of the data bus may be sufficient to communicate the processed image data with some overhead for additional communication. However, the data bus may not have enough bandwidth to communicate all the captured image data if the image data was not processed. Therefore, the present system may be able to take advantage of information captured by a high-quality camera system without the processing and data movement requirements of a traditional image processing system.

The data bus connects the various optical systems (including image processors) located throughout a vehicle to an additional computing system. The additional computing system may include both data storage and a vehicle control system. Thus, the data bus functions to move the compressed image data from the optical systems where image data is captured and processed to a computing system that may be able to control autonomous vehicle functions, such as autonomous control.

At block 508, the system operates by storing the compressed image data in a memory of the computing system. The image data may be stored in the compressed format that was created at block 504. The memory may be a memory within a computing system of the vehicle that is not directly located with the optical system(s). In some additional examples, there may be a memory that is located at a remote computer system that is used for data storage. In examples where the memory is located at a remote computer system, a computing unit of the vehicle may have a data connection that allows the image data to be communicated wirelessly to the remote computing system.

At block 510, the system operates by controlling an apparatus based on the compressed image data by a vehicle-control processor of the computing system. In some examples, the image data may be used by a vehicle control system to determine a vehicle instruction for execution by the autonomous vehicle. For example, a vehicle may be operating in an autonomous mode and alter its operation based on information or an object captured in an image. In some examples, the image data may be related to a different control system, such a remote computing system, to determine a vehicle control instruction. The autonomous vehicle may receive the instruction from the remote computing system and responsively alter its autonomous operation.

The apparatus may be controlled based on a computing system recognizing object and/or features of the captured image data. The computing system may recognize obstacles and avoid them. The computing system may also recognize roadway markings and/or traffic control signals to enable safe autonomous operation of the vehicle. The computing system may control the apparatus in a variety of other ways as well.

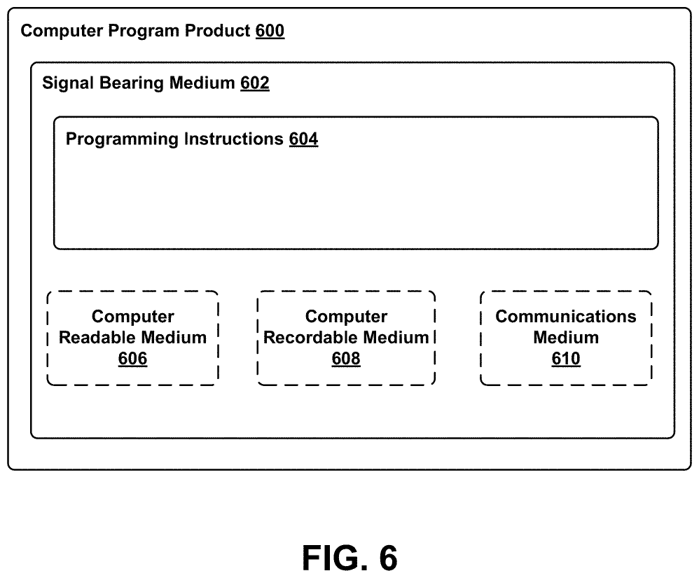

FIG. 6 is a schematic diagram of a computer program, according to an example implementation. In some implementations, the disclosed methods may be implemented as computer program instructions encoded on a non-transitory computer-readable storage media in a machine-readable format, or on other non-transitory media or articles of manufacture.

In an example implementation, computer program product 600 is provided using signal bearing medium 602, which may include one or more programming instructions 604 that, when executed by one or more processors may provide functionality or portions of the functionality described above with respect to FIGS. 1-5. In some examples, the signal bearing medium 602 may encompass a non-transitory computer-readable medium 606, such as, but not limited to, a hard disk drive, a CD, a DVD, a digital tape, memory, components to store remotely (e.g., on the cloud) etc. In some implementations, the signal bearing medium 602 may encompass a computer recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Similarly, the signal bearing medium 602 may correspond to a remote storage (e.g., a cloud). A computing system may share information with the cloud, including sending or receiving information. For example, the computing system may receive additional information from the cloud to augment information obtained from sensors or another entity. Thus, for example, the signal bearing medium 602 may be conveyed by a wireless form of the communications medium 610.

The one or more programming instructions 604 may be, for example, computer executable and/or logic implemented instructions. In some examples, a computing device such as the computer system 112 of FIG. 1 or remote computing system 302 and perhaps server computing system 306 of FIG. 3A or one of the processors of FIG. 3B may be configured to provide various operations, functions, or actions in response to the programming instructions 604 conveyed to the computer system 112 by one or more of the computer readable medium 606, the computer recordable medium 608, and/or the communications medium 610.

The non-transitory computer readable medium could also be distributed among multiple data storage elements and/or cloud (e.g., remotely), which could be remotely located from each other. The computing device that executes some or all of the stored instructions could be a vehicle, such as vehicle 200 illustrated in FIG. 2. Alternatively, the computing device that executes some or all of the stored instructions could be another computing device, such as a server.

The above detailed description describes various features and operations of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

What is claimed is:

1. An apparatus comprising:
an optical system configured with:
(i) a plurality of camera sensors, wherein the plurality of camera sensors includes at least one camera sensor pair comprising a first camera sensor and a second camera sensor, wherein the first and second camera sensors have a common field of view, wherein the first camera sensor has a first dynamic range, and wherein the second camera sensor has a second dynamic range that is different than the first dynamic range, and
(ii) a plurality of image processing units coupled to the plurality of camera sensors, wherein the image processing units are configured to compress the image data captured by the camera sensors, wherein the image processing units are located within an electrical distance of 6 inches of the camera sensors, and wherein the plurality of image processing units includes at least a first image processing unit configured to compress image data captured by the first camera sensor and a second image processing unit configured to compress image data captured by the second camera sensor; and
a computing system configured with:
(i) a memory configured to store the compressed image data;
(ii) a vehicle-control processor configured to control a vehicle based on the compressed image data, and
(iii) a data bus configured to communicate the compressed image data between the optical system and the computing system.

2. The apparatus of claim 1, wherein the data bus has a bandwidth that is greater than or equal to a bandwidth of the compressed image data, and wherein the data bus bandwidth is less than an bandwidth for the transmission of unprocessed image data.

3. The apparatus of claim 2, wherein the plurality of camera sensors includes eight camera sensor pairs, wherein the eight camera sensor pairs are arranged in a circular ring.

4. The apparatus of claim 3, wherein the circular ring is configured to rotate.

5. The apparatus of claim 1, wherein the first and second image processing units are configured to process the image data captured by the first and second camera sensors in parallel.

6. The apparatus of claim 1, wherein each image processing unit is configured to compress a plurality of images by maintaining a first set of one or more images in the plurality of images and extracting motion data associated with a second set of one or more images in the plurality of images.

7. The apparatus of claim 1, wherein the optical system is mounted in a sensor dome of the vehicle.

8. The apparatus of claim 1, wherein the optical system is mounted behind a windshield of the vehicle.

9. The apparatus of claim 1, wherein the first dynamic range corresponds to a first range of luminance levels and the second dynamic range corresponds to a second range of luminance levels, wherein the second range of luminance levels includes luminance levels that are higher than the first range of luminance levels.

10. A method comprising:
providing light to a plurality of camera sensors of an optical system to create image data, wherein the plurality of camera sensors includes at least one camera sensor pair comprising a first camera sensor and a second camera sensor, wherein the first and second camera sensors have a common field of view, wherein the first camera sensor has a first dynamic range, and wherein the second camera sensor has a second dynamic range that is different than the first;
compressing the image data by a plurality of image processing units coupled to the plurality of camera sensors, and wherein the image processing units are located within an electrical distance of 6 inches of the camera sensors, wherein the plurality of image processing units includes at least a first image processing unit that compresses image data captured by the first camera sensor and a second image processing unit that compresses image data captured by the second camera sensor;
communicating the compressed image data from the plurality of image processing units to a computing system;
storing the compressed image data in a memory of the computing system; and
controlling a vehicle based on the compressed image data by a vehicle-control processor of the computing system.

11. The method of claim 10, wherein the first and second image processing units are configured to process the image data captured by the first and second camera sensors in parallel.

12. The method of claim 10, wherein compressing the image data comprises each image processing unit compressing a plurality of images by maintaining a first set of one or more images in the plurality of images and extracting motion data associated with a second set of one or more images in the plurality of images.

13. The method of claim 10, wherein compressing the image data comprises storing a first image as a reference image and storing data related to changes with respect to the reference image for subsequent images, and storing a new reference image after a threshold is met.

14. The method of claim 10, wherein the first dynamic range corresponds to a first range of luminance levels and the second dynamic range corresponds to a second range of luminance levels, wherein the second range of luminance levels includes luminance levels that are higher than the first range of luminance levels.

15. A vehicle comprising:
a roof-mounted sensor unit comprising:
an optical system configured with a plurality of camera sensors and a plurality of image processing units coupled to the plurality of camera sensors, wherein the plurality of camera sensors includes at least one camera sensor pair comprising a first camera sensor and a second camera sensor, wherein the first and second camera sensors have a common field of view, wherein the first camera sensor has a first dynamic range, wherein the second camera sensor has a second dynamic range that is different than the first dynamic range, wherein the image processing units are configured to compress the image data captured by the camera sensors, wherein the image processing units are located within an electrical distance of 6 inches of the camera sensors, and wherein the plurality of image processing units includes at least a first image processing unit configured to compress image data captured by the first camera sensor and a second image processing unit configured to compress image data captured by the second camera sensor; and
a computing system located in the vehicle outside of the roof-mounted sensor unit, comprising a memory configured to store the compressed image data, a control system configured to control the vehicle based on the compressed image data, and a data bus configured to communicate the compressed image data between the roof-mounted sensor unit and the computing system.

16. The vehicle of claim 15, wherein the first and second image processing units are configured to process the image data captured by the first and second camera sensors in parallel.

17. The vehicle of claim 15, wherein plurality of camera sensors includes eight sensor pairs, wherein the eight sensor pairs are arranged in a circular ring.

18. The vehicle of claim 17, wherein the circular ring is configured to rotate.

19. The vehicle of claim 15, wherein the first dynamic range corresponds to a first range of luminance levels and the second dynamic range corresponds to a second range of luminance levels, wherein the second range of luminance levels includes luminance levels that are higher than the first range of luminance levels.

20. The vehicle of claim 15, wherein each image processing unit is configured to compress a plurality of images by maintaining a first set of one or more images in the plurality of images and extracting motion data associated with a second set of one or more images in the plurality of images.
